(19) United States
(12) Patent Application Publication
(10) Pub. No.: US 2017/0062979 A1
(43) Pub. Date: Mar. 2, 2017

(54) Female Connector, and Connection Structure of Female Connector and Male Connector

(71) Applicants: Nintendo Co., Ltd., Kyoto-shi (JP); HOSIDEN CORPORATION, Osaka (JP)

(72) Inventors: Kumpei Fujita, Kyoto-shi (JP); Hiroki Ikuta, Kyoto-shi (JP); Shinji Hirose, Kyoto-shi (JP); Naoki Yamachika, Yao-shi (JP); Hideaki Taketsu, Yao-shi (JP)

(21) Appl. No.: 15/233,185

(22) Filed: Aug. 10, 2016

(30) Foreign Application Priority Data
Aug. 28, 2015 (JP) 2015-169554

(51) Int. Cl. H01R 13/631

(52) U.S. Cl. CPC H01R 13/631

(57) ABSTRACT

A female connector including a guide extending in a first direction, a pair of support portions on one side in the first direction relative to the guide, an insulative female body between the support portions, a female terminal held in the female body, and a shaft. The guide guides a mating male connector in the first direction floatably along a second direction orthogonal to the first direction. The support portions are spaced from each other in the second direction and each have a support hole passing therethrough in the second direction. The female body has a through hole passing in the second direction through at least a portion in the second direction of the female body. The shaft is received in the support holes of the support portions and the through hole of the female body so as to support the female body floatably along the second direction.

### CROSS-REFERENCE TO RELATED APPLICATION

The present application claims priority under 35 U.S.C. §119 of Japanese Patent Application No. 2015-169554 filed on Aug. 28, 2015, the disclosure of which is expressly incorporated by reference herein in its entirety.

### BACKGROUND OF THE INVENTION

Technical Field

The invention relates to female connectors, and connection structures of female connectors and male connectors.

Background Art

A conventional female connector is disclosed in Japanese Unexamined Patent Publication No. H05-82207. The female connector includes a body, a plurality of terminals held in the body, a plate, a metal part, a pair of springs, and a floating structure. The body is a rectangular insulative plate having a back face, a first side face, and a second side face. The metal part, generally U-shaped in plan view, includes a central plate, a first side plate, and a second side face to respectively cover the back face, the first side face, and the second side face of the body. The springs hold the body in a horizontally movable manner, with one of the springs disposed between the first side face of the body and the first side plate of the metal part, and the other spring disposed between the second side face of the body and the second side plate of the metal part. The plate has a window for detachably receiving a male connector. The floating structure includes a pair of mounting holes elongated horizontally in the body, a pair of bosses on the plate, and a pair of screws. The bosses are received in the holes such as to be movable horizontally. The screws are screwed to the bosses through the metal part and the body. Releasing the screws enables the bosses to move horizontally inside the holes, so that the body is floatable along the horizontal direction relative to the plate.

### SUMMARY OF INVENTION

The above conventional connector floating structure requires the pair of mounting holes, the pair of bosses, and the pair of screws, resulting in a large number of components for the floating structure.

The invention is devised in view of the above circumstances and provides a female connector equipped with a floating structure consisting of a reduced number of components. The invention also provides a connection structure of such a female connector and a male connector.

A female connector according to an aspect of the invention is used for mating with a male connector and includes a guide, a pair of support portions, a female body, a female terminal, and a shaft. The guide extends in a first direction and is configured to guide the male connector in the first direction such that the male connector is floatable along a second direction. The second direction is orthogonal to the first direction. The support portions are located on one side in the first direction relative to the guide and spaced from each other in the second direction, and each support portion has a support hole passing therethrough in the second direction. The female body is insulative and disposed between the support portions, and has a through hole passing in the second direction through at least a portion in the second direction of the female body. The female terminal is held in the female body. The shaft is received in the support holes of the support portions and the through hole of the female body so as to support the female body floatably along the second direction.

The female connector of this aspect is equipped with a floating structure in which the female body of the female connector is floatable along the second direction. The floating structure is comprised of the shaft, the support holes of the support portions, and the through hole of the female body. This floating structure of the female connector is advantageously reduced in number of components.

In the female connector according to another aspect of the invention, the shaft may extend through at least a portion in the second direction of the female body in the second direction, and may be fixed to the female body. In this case, the shaft may be fixed to the female body by insert molding or other means, or the shaft may extend in the second direction through the through hole of the female body, and fixed to the through hole of the female body. In the former case, the through hole is omitted. The shaft is preferably received in the support holes of the support portions such as to be floatable along the second direction.

The floating structure of this aspect enabling the female body of the female connector to float along the second direction is comprised of the shaft, the support holes of the support portions, and the female body. This floating structure of the female connector is advantageously reduced in number of components.

The female connector according to still another aspect of the invention does not include a shaft and has the following configuration. The female body includes at least one opposing portion facing the support portions. The opposing portion includes a shaft part extending in the second direction, and the support portions have a support hole receiving the shaft part such that the shaft part is floatable along the second direction. Alternatively, the support portions include a shaft part extending in the second direction, and the opposing portion has a support hole receiving the shaft part such that the shaft part is floatable along the second direction.

The floating structure of this aspect enabling the female body of the female connector to float along the second direction is comprised of the shaft part and the support hole. This floating structure of the female connector is advantageously reduced in number of components.

The guide may include a pair of rails extending in the first direction. In this case, the rails may be configured to guide a runner of the male connector in the first direction, with the runner being received between the rails with a clearance in the second direction. Alternatively, the guide may include at least one rail extending in the first direction. In this case, the rail may be configured to guide the male connector in the first direction, with the rail being received, with a clearance in the second direction, in a runner groove of a runner of the male connector.

The female connector of any aspect above may further include a pair of covers. The covers may extend from the respective support portions such as to cover the female body from one side in a third direction. The third direction may be orthogonal to the first and second directions. The female terminal may include a contact portion exposed to the other side in the third direction out of the female body. The guide may further include a bottom between the rails. The bottom may be located on the other side in the third direction relative to the contact portion of the female terminal.

The floating structure of this aspect reduces the risk that a user of the female connector touches the contact of the female terminal. More particularly, the risk of touching the contact portion from the one side in the third direction is reduced because the female body holding the female terminal is covered with the cover on one side in the third direction, and because the contact portion of the female terminal is exposed out of the female body to the other side in the third direction. It is also difficult for a user of the female connector to touch the contact portion of the female terminal from the other side in the third direction because the contact portion of the female terminal is exposed out of the female body to the other side in the third direction but the bottom of the guide is located on the other side in the third direction relative to the contact portion of the female terminal.

The guide may include a pair of first abutment portions. The female connector may further include a female biasing portion. The female biasing portion may be provided at the guide such as to bias the male connector to one side in the third direction to bring the male connector into abutment with the first abutment portions.

The floating structure of this aspect minimizes backlash in the third direction between the female connector and the male connector guided the guide of the female connector. This is because the female body and the male connector are held in the third direction by and between the first abutment portions and the female biasing portion.

The female connector of any aspect above may further include a pair of second biasing portions and a female biasing portion. The second abutment portions may extend from the respective support portions and abut the female body from one side in the third direction. The female biasing portion may be provided at the guide such as to bias the male connector to the one side in the third direction to bring a male terminal of the male connector into elastic contact with the female terminal. The second biasing portions may function as the covers.

The floating structure of this aspect minimizes backlash in the third direction between the male connector and the female connector when the male terminal of the male connector is in contact with the female terminal of the female connector. This is because the female body and the male connector are held in the third direction by and between the second biasing portions and the female biasing portion.

The guide may further include a bottom between the rails. The bottom may include an end portion on the one side in the first direction. The end portion may have an opening passing through the bottom in the third direction.

The floating structure of this aspect is suitably configured for readily removing unwanted materials (e.g. dust, lint, dirt, etc.) accumulated on the bottom of the guide. Particularly, when the runner of the male connector is guided in the first direction by the rail, the runner pushes unwanted materials on the bottom outwardly and eject them through the opening in the bottom of the guide.

A connection structure of an aspect of the invention includes the female connector of any aspect above and a male connector. The male connector includes a runner, a male body, and a male terminal. The runner may be configured to be guided in the first direction by the guide of the female connector such that the runner is floatable along the second direction. The male terminal may be held in the male body and contactable with the female terminal of the female connector.

The guide of the female connector may further include a female engagement portion. The male connector may further include a male engagement portion.

The female engagement portion may be an engagement hole extending in the second direction. The male body may include an accommodation portion configured to accommodate the male engagement portion such that the male engagement portion is movable in the second direction. The male connector may further include a male biasing portion. The male biasing portion may be configured to exert an biasing force on the male engagement portion to one side in the second direction. The guide of the female connector may be configured such that, while guiding the runner of the male connector, the guide presses and moves the male engagement portion to the other side in the second direction against the biasing force of the male biasing portion. The male engagement portion may be configured such that, when the male terminal is brought into contact with the female terminal and the accommodation portion is brought into communication with the female engagement portion, the male engagement portion is moved to the one side in the second direction by the biasing force of the male biasing portion and engages with the female engagement portion.

In the connection structure of this aspect, when connecting the male connector to the female connector, the male engagement portion is biased by the male biasing portion and automatically brought into engagement with the female engagement portion.

If the female engagement portion is an engagement hole, the male engagement portion may be an engagement protrusion to engage with the engagement hole when the male terminal contacts the female terminal. Alternatively, the male engagement portion may be an engagement hole, and the female engagement portion may be an engagement protrusion to engage with the engagement hole when the male terminal contacts the female terminal.

### BRIEF DESCRIPTION OF DRAWINGS

The present invention can be even more fully understood with the reference to the accompanying drawings which are intended to illustrate, not limit, the present invention.

FIG. 1A is a front, top, right side perspective view of a connection structure of the first embodiment of the invention, in which the male connector is yet to be connected to the female connector.

FIG. 1B is a front, top, right side perspective view of the connection structure, in which the male connector is connected to the female connector.

FIG. 1C is a sectional view of the connection structure, taken along 1C-1C in FIG. 1B.

FIG. 1D is a sectional view of the connection structure, taken along 1D-1D in FIG. 1B.

FIG. 1E is a sectional view of the connection structure, taken along 1E-1E in FIG. 1B.

FIG. 2A is a front, bottom, left side perspective view of the female connector.

FIG. 2B is a rear, top, right side perspective view of the female connector.

FIG. 2C is a front, bottom, left side perspective and exploded view of the female connector.

FIG. 2D is a back, top, left side perspective and exploded view of the female connector.

FIG. 3A is a front, top, left side perspective view of the male connector.

FIG. 3B is a rear, bottom, right side perspective view of the male connector.

FIG. 3C is a front, top, left side perspective and exploded view of the male connector.

FIG. 3D is a back, bottom, right side perspective and exploded view of the male connector.

FIG. 4 is a front, top, right side perspective view of a connection structure of the second embodiment of the invention, in which the male connector is yet to be connected to the female connector.

FIG. 5 is a view of a variant female connector of the connection structures of the first and second embodiments.

In the brief description of the drawings above and the description of embodiments which follows, relative spatial terms such as “upper”, “lower”, “top”, “bottom”, “left”, “right”, “front”, “rear”, etc., are used for the convenience of the skilled reader and refer to the orientation of the female connectors, and the connection structures of female connectors and male connectors, and their constituent parts as depicted in the drawings. No limitation is intended by use of these terms, either in use of the invention, during its manufacture, shipment, custody, or sale, or during assembly of its constituent parts or when incorporated into or combined with other apparatus.

### DESCRIPTION OF EMBODIMENTS

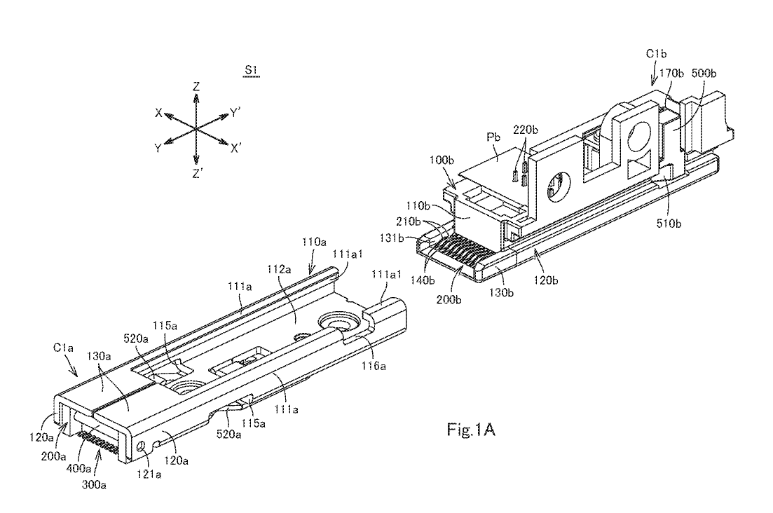

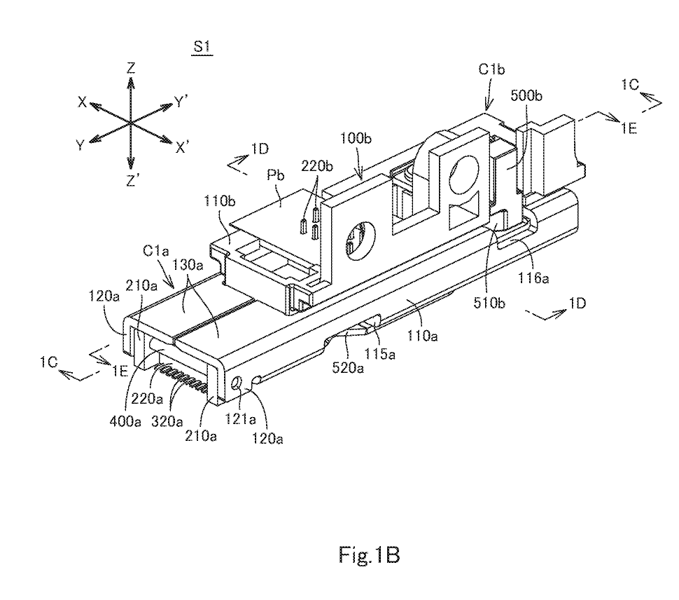

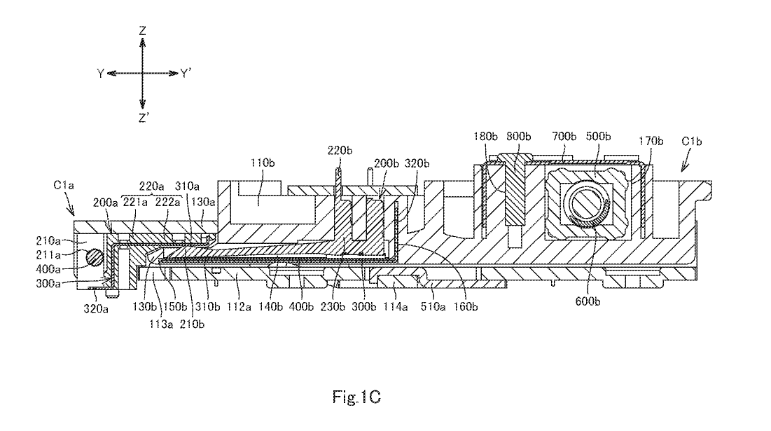

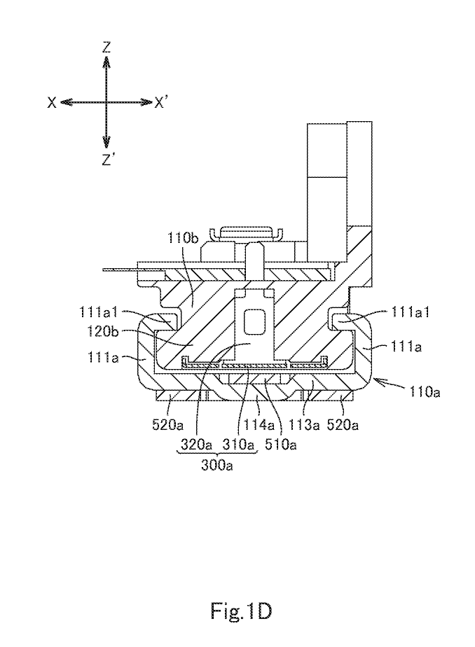

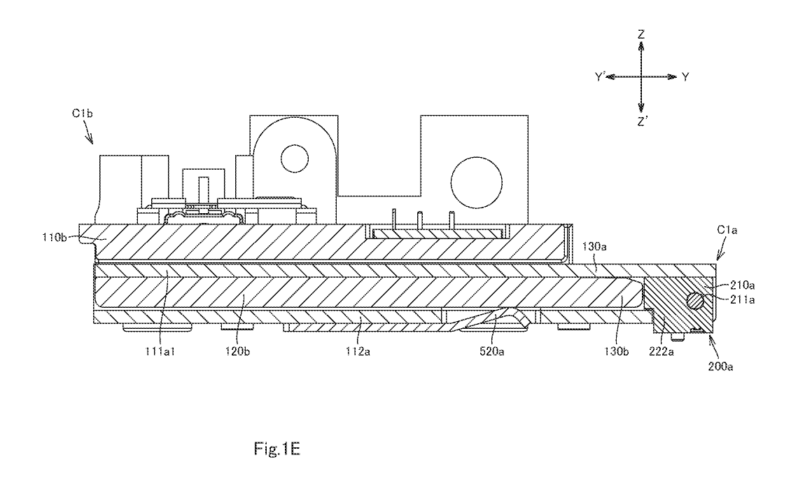

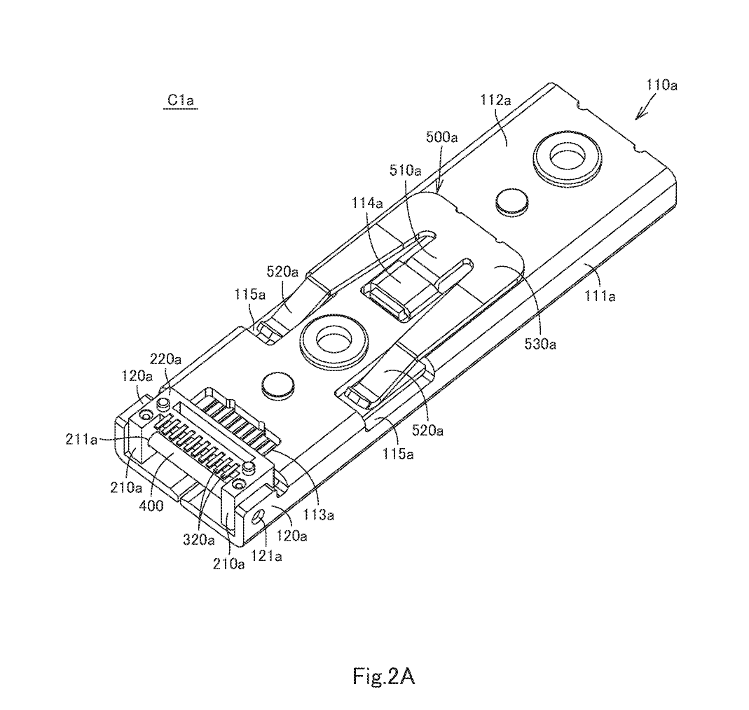

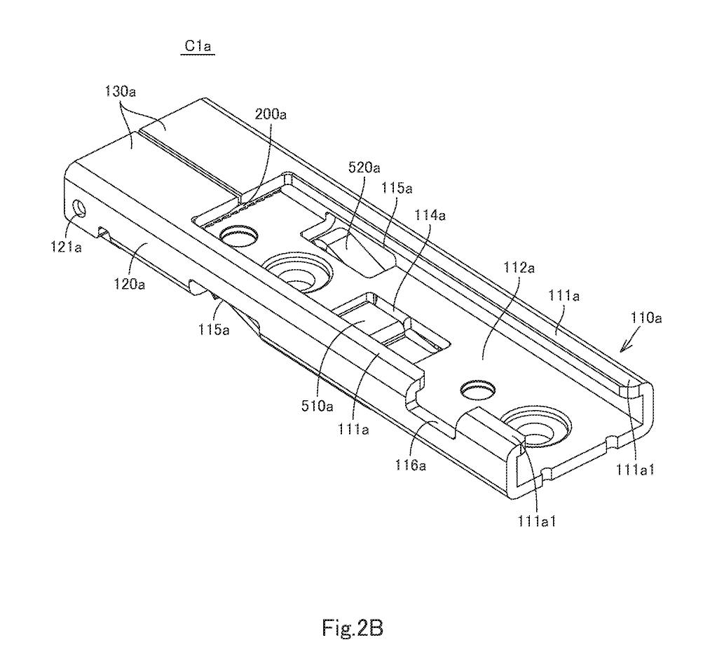

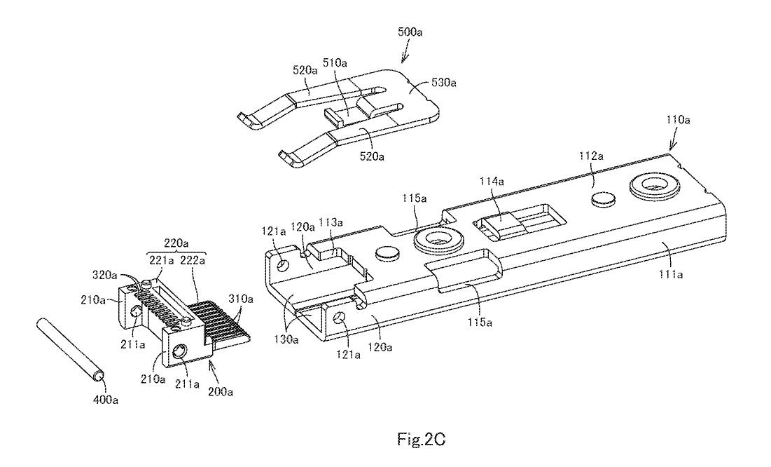

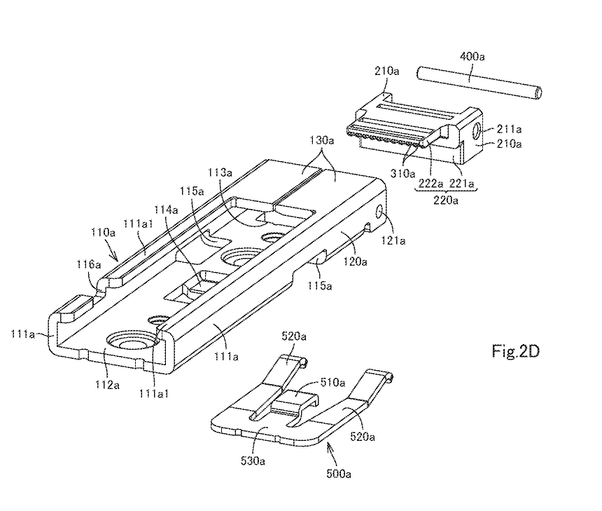

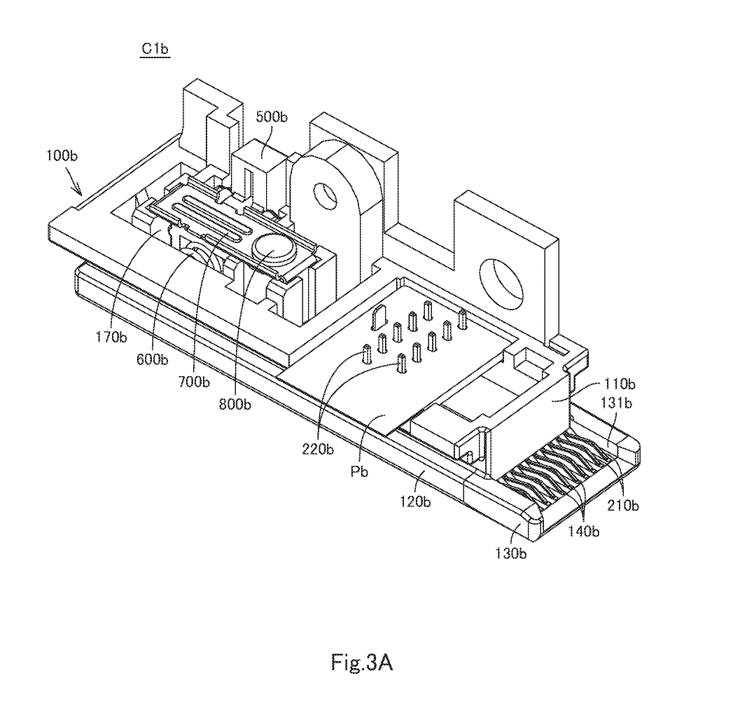

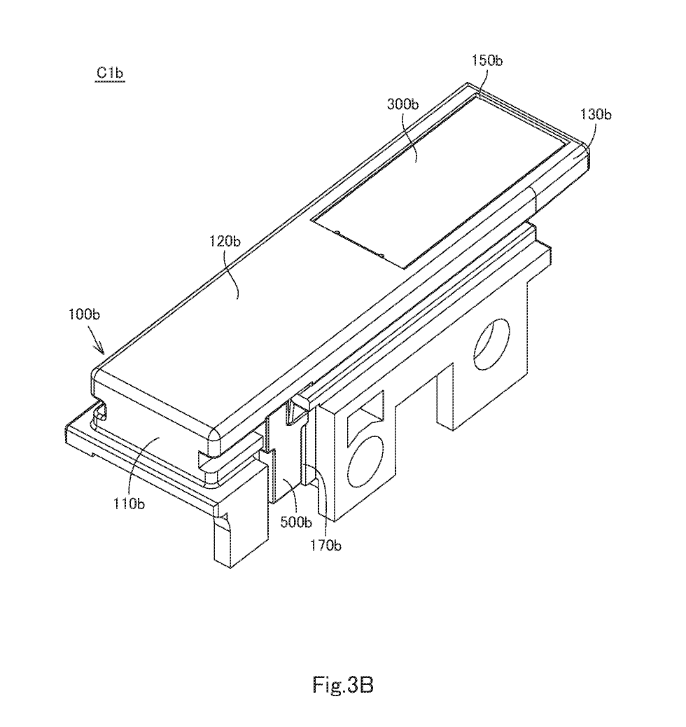

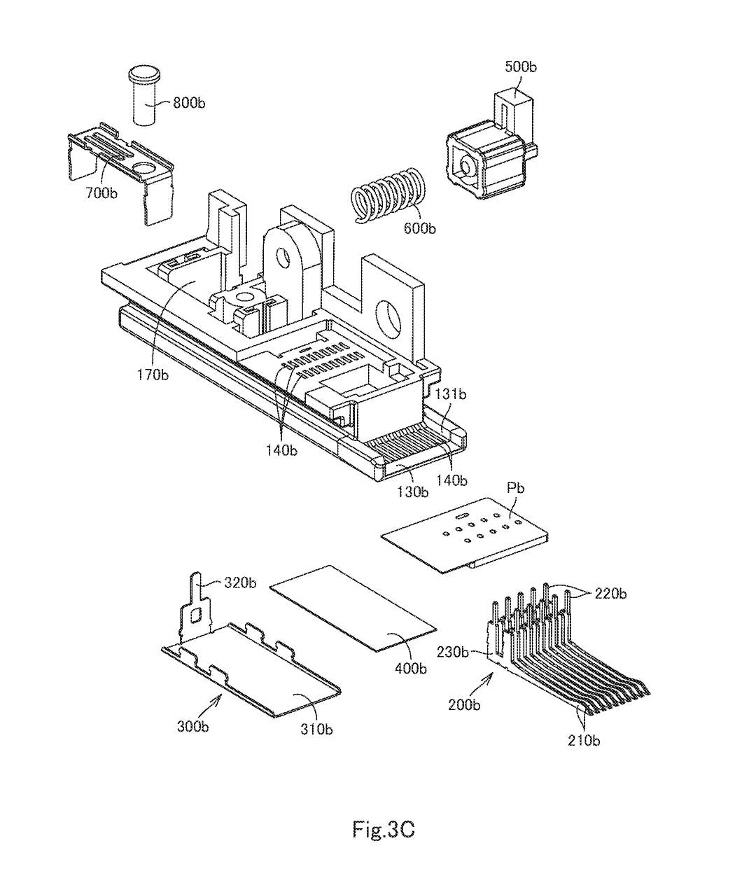

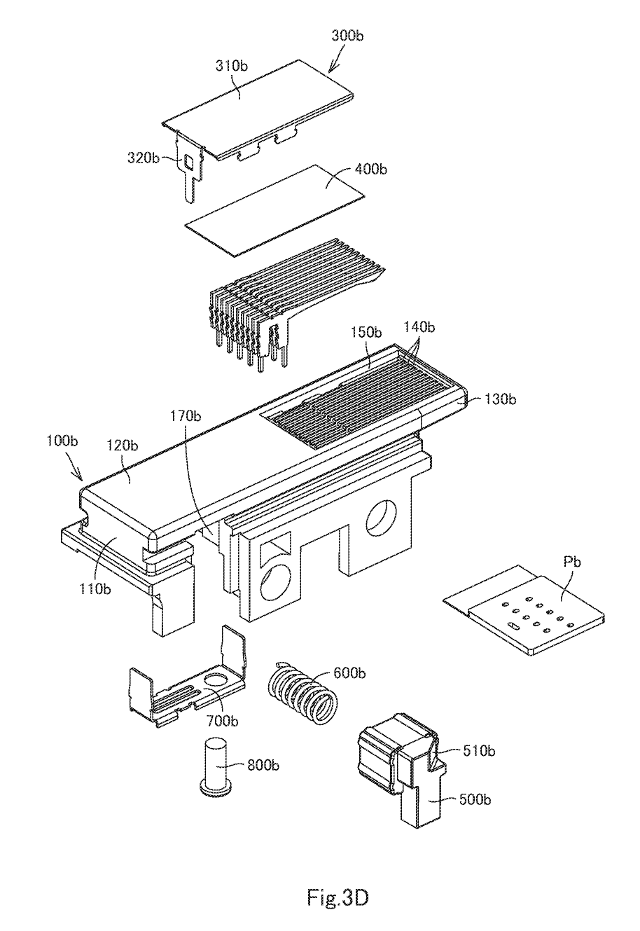

A connection structure S1 according to some embodiments of the invention includes a female connector C1a and a male connector C1b. FIGS. 1 to 3D shows an embodiment (hereinafter referred to as the first embodiment) of the connection structure S1. The female connector C1a will be described referring to FIGS. 1A to FIG. 2D, and the male connector C1b will be described referring to FIGS. 1A to 1E and FIGS. 3A to 3D. It should be appreciated that FIGS. 1A to 1C and FIG. 1E indicate the Y-Y′ direction, in which the male connector C1b is guided by a guide 110a (to be described) of the female connector C1a. The Y-Y′ direction corresponds to the “first direction” set forth in the claims. FIGS. 1A, 1B, and 1D indicates the X-X′ direction, which corresponds to the “second direction” in the claims. The X-X′ direction is orthogonal to the Y-Y′ direction. FIGS. 1A to 1E indicates the Z-Z′ direction, which is the height direction of the female connector C1a and the male connector C1b and corresponds to the “third direction” set forth in the claims. The Z-Z′ direction is orthogonal to the Y-Y′ and X-X′ directions.

The male connector C1b may preferably include a body 100b (hereinafter referred to as a male body 100b), a runner 120b, and a plurality of terminals 200b (hereinafter referred to as male terminals 200b).

The male body 100b is made of an insulating resin. The male body 100b may include a male main body 110b. The male main body 110b is a block, i.e. a solid piece of insulating resin.

The runner 120b may be of any configuration as long as it can be guided movably in the Y-Y′ direction by the guide 110a (to be described) of the female connector C1a such as to be floatable along the X-X′ direction. For example, the runner 120b may be a plate extending in the Y-Y′ and X-X′ directions, an elongate projection extending in the Y-Y′ direction, a plurality of elongate projections extending in the Y-Y′ direction and being arranged in spaced relation in the X-X′ direction, a row of projections spaced in the Y-Y′ direction, or a plurality of rows of projections spaced in the Y-Y′ direction. The rows may preferably be spaced in the X-X′ direction. The runner 120b may be integral with any suitable part of the male main body 110b, or may be formed separately from the male main body 110b and fixed to any suitable part of the male main body 110b.

In FIGS. 1A to 1E and FIGS. 3A to 3D, the runner 120b is a rectangular plate extending in the X-X′ and Y-Y′ directions to be integral with the Z′-direction end of the male main body 110b. The runner 120b is larger in the X-X′ direction than the Z′-direction end of the male main body 110b.

The female connector C1a may include the guide 110a, a pair of support portions 120a, a female body 200a, a plurality of female terminals 300a, and a shaft 400a.

The guide 110a extends in the Y-Y′ direction. The guide 110a may preferably be configured to guide the runner 120b of the male connector C1b in the Y-Y′ direction between an initial position and a connection position such that the runner 120b is floatable along the X-X′ direction. Here the initial position is the position at which the guide 110a starts to guide the runner 120b. The connection position is the position at which the male connector C1b is connected to the female connector C1a, i.e. the position at which the male terminals 200b (to be described) of the male connector C1b are in contact with the associated female terminals 300a of the female connector C1a.

The guide 110a may take a variety of forms, such as at least one frame extending in the Y-Y′ direction, or at least one rail groove extending in the Y-Y′ direction. The guide 110a, i.e. the or each frame or the or each rail groove, may include a pair of rails 111a. The rails 111a of the at least one frame are plates extending in the Y-Y′ direction and are spaced from each other in the X-X′ direction. The rails 111a of the at least one rail groove are walls on the X- and X′-direction sides of the rail groove, extend in the Y-Y′ direction, and are spaced from each other in the X-X′ direction. In either case, the rails 111a may be configured to guide the runner 120b (i.e., the plate, one or more elongate projections, or one or more rows of projections) in the Y-Y′ direction such that the runner 120b is floatable along the X-X′ direction. Accordingly, the runner 120b is receivable in between the rails 111a with a clearance in the X-X′ direction. More specifically, the X-X′ direction distance between the rails 111a may preferably be slightly larger than the X-X′ direction dimension of the runner 120b. FIGS. 1A to FIG. 2D illustrates the guide 110a as having a frame, which has a pair of rails 111a extend in the Z-Z′ direction and then closer to each other to each form a generally L-shape. The guide 110a may include more than one frame or more than one rail groove.

Depending on the specific configuration of the runner 120b, the X-X′ direction dimension of the runner 120b may specifically be: a) the X-X′ direction dimension of the plate; b) the X-X′ direction dimension of the elongate projection; c) the X-X′ direction dimension of the row of projections; d) the X-X′ direction distance between the outer end faces of the outermost ones of the elongate projections arranged in the X-X′ direction; or e) the X-X′ direction distance between the outer end faces of the projections in the outermost rows out of the plurality of rows arranged in the X-X′ direction.

The support portions 120a are provided on the Y-direction side (one side in the first direction) of the guide 110a and are spaced from each other in the X-X′ direction. For example, the support portions 120a may extend in the Y direction from the respective Y-direction ends of the rails 111a of the guide 110a as at least one frame, as shown in FIG. 1A to FIG. 2D. Or alternatively, the support portions 120a may extend in the Y direction from the respective Y-direction ends of the rails 111a of the guide 110a as at least one rail groove. The support portions 120a each have a support hole 121a passing therethrough in the X-X′ direction. The support holes 121a have a Z-Z′ direction height that may preferably be determined in accordance with the Z-Z′ direction height of the male connection portion 130b (to be described) or the male connection hole (to be described) of the male connector C1b.

The female body 200a is formed of an insulating resin. The female body 200a has an X-X′ direction dimension that is smaller than the X-X′ direction distance between the support portions 120a. The female body 200a is disposed between the support portions 120a. The female body 200a may have at least one through hole 211a. The through hole 211a may preferably pass in the X-X′ direction through at least a portion in the X-X′ direction of the female body 200a. In other words, the through hole 211a may pass in the X-X′ direction through the entire width in the X-X′ direction of the female body 200a. The female body 200a may include at least one wing 210a and a female main body 220a. The at least one wing 210a may preferably extend from the female main body 220a in a direction containing a Y′-, Y-, Z-, or Z′-direction component. The or each through hole 211a preferably passes in the X-X′ direction through the associated wing 210a. The embodiment of FIG. 1A to FIG. 2D includes a pair of wings 210a extending in the Y direction from the X- and X′-direction ends, respectively, of the Y-direction end face of the female main body 220a. The wings 210a each have a through hole 211a passing therethrough in the X-X′ direction.

The shaft 400a is a metal or plastic rod of a circular cylindrical or polygonal columnar shape extending in the X-X′ direction. The shaft 400a may be received in the support holes 121a of the pair of support portions 120a and the at least one through hole 211a of the female body 200a such as to support the female body 200a floatably, i.e. movably, in the X-X′ direction. To this end, the shaft 400a may have an outer diameter corresponding to the diameter of the or each support hole 121a, or the shaft 400a may have an outer size corresponding to the size of the or each support hole 121a. In other words, the shaft 400a fits in the support holes 121a. Also, the outer diameter of the shaft 400a is slightly larger than the diameter of the or each through hole 211a of the female body 200a, or the outer size of the shaft 400a is slightly larger than the size of the or each through hole 211a of the female body 200a. The female body 200a is thus floatable along the X-X′ direction relative to the shaft 400a. In this case, the floating structure of the female connector C1a is comprised of the support holes 121a of the support portions 120a, the through hole or holes 211a of the female body 200a, and the shaft 400a.

Alternatively, the shaft 400a may be fixed to the female body 200a such as to extend through at least a portion of the female body 200a, and received in the support holes 121a of the pair of support portions 120a such as to be floatable, i.e. movable, along the X-X′ direction. Specifically, the shaft 400a may be insert-molded in at least the portion of the female body 200a (for example, the wings 210a), or, as shown in FIG. 1A to FIG. 2D, may be fixed to the through hole 211a such as to extend through the through hole or holes 211a of the female body 200a. The outer diameter of the shaft 400a is slightly smaller than the diameter of each support hole 121a, or the outer size of the shaft 400a is slightly smaller than the size of each support hole 121a. The shaft 400a is thus received and supported in the support holes 121a such as to be floatable along the X-X′ direction. In other words, the female body 200a and the shaft 400a are supported in the support holes 121a of the support portions 120a such as to be floatable along the X-X′ direction. In this case, the floating structure of the female connector C1a is comprised of the support holes 121a of the support portions 120a, the female body 200a, and the shaft 400a. If the shaft 400a is insert-molded in at least the portion of the female body 200a, the through hole 211a is omitted.

For example, the female main body 220a of the female body 200a may be a block (i.e. a solid piece of insulating resin) of a rectangular, generally L-shaped, or generally T-shaped cross-section in Y-Y′ direction. In the embodiment of FIG. 1A to FIG. 2D where the female main body 220a is a block of generally L-shape in Y-Y′ direction cross-section, the female main body 220a includes a base 221a and a tongue 222a, and the tongue 222a extends in the Y′ direction from the Z-direction end of the Y′-direction end face of the base 221a. In an embodiment where the female main body 220a is a block of generally T-shape in Y-Y′ direction cross-section, the female main body 220a may include a base 221a and a tongue 222a, and the tongue 222a may extend in the Y′ direction centrally from the Y′-direction end face of the base 221a.

The female main body 220a may preferably have one of the following configurations (1) to (3), but not limited thereto, so that the female connector C1a is connectable to the male connector C1b.

(1) The Y′-direction end portion of the rectangular female main body 220a or the tongue 222a of the T- or L-shaped female main body 220a may serve as a connection portion (hereinafter referred to as a female connection portion) of the female connector C1a. The female connection portion may preferably be receivable in a connection hole (hereinafter referred to as a male connection hole) of the male connector C1b as located in the connection position.

(2) The Y′-direction end portion of the rectangular female main body 220a or the tongue 222a of the T- or L-shaped female main body 220a may serve as a female connection portion of the female connector C1a, and the female connection portion may have a space on the Z- and/or Z′-direction side to serve as connection hole (hereinafter referred to as a female connection hole). The female connection hole may preferably be defined by at least the female connection portion and the pair of support portions 120a. In this case, the female connection portion may preferably be receivable in the male connection hole of the male connector C1b as located in the connection position, and the female connection hole may preferably be configured to receive the male connection portion 130b (to be described) of the male connector C1b.

(3) The Y′-direction end portion of the rectangular female main body 220a or the tongue 222a of the T- or L-shaped female main body 220a may have a female connection hole (not shown) opening in the Y′-direction. The female connection hole may preferably be configured to receive the male connection portion 130b of the male connector C1b as located in the connection position.

In the embodiment of FIG. 1A to FIG. 2D, the female connector C1a includes a tongue 222a, which serves as the female connection portion and has a space on the Z′-direction side to serve as the female connection hole.

The female body 200a holds the female terminals 300a in spaced relation in the X-X′ direction such that the female terminals 300a are contactable with male terminals 200b (to be described) of the male connector C1b as located in the connection position. More particularly, the female body 200a may have a plurality of holding grooves (not shown) spaced from each other in the X-X′ direction. In this case, the female terminals 300a are securely press-fitted in the respective holding grooves of the female body 200a. Alternatively, the female terminals 300a may be insert-molded inside the female body 200a in spaced relation in the X-X′ direction, as in the embodiment of FIG. 1A to FIG. 2D.

The female terminals 300a may be metal plates generally of L-shape or any shape extending in a direction containing a Y-Y′ direction component. The female terminals 300a each include a contact portion 310a and a tail 320a. The contact portions 310a of the female terminals 300a are exposed or protrude out of the female body 200a such as to be contactable with associated contact portions 210b of the male terminals 200b as located in the connection position. More particularly, (1) if the female connector C1a includes the female connection portion, the contact portions 310a may preferably be exposed or protrude out of the face on the Z- or Z′-direction side of the female connection portion. (2) If the female connector C1a includes the female connection portion and the female connection hole, the contact portions 310a may preferably be exposed or protrude out of the Z-direction face of the female connection portion such as to be disposed inside the female connection hole on the Z-direction side of the female connection portion, or the contact portions 310a are exposed or protrude out of the Z′-direction face of the female connection portion such as to be disposed inside the female connection hole on the Z′-direction side of the female connection portion. (3) If the female connector C1a includes the female connection hole, the contact portions 310a may preferably be disposed inside the female connection hole. In the embodiment of FIG. 1A to FIG. 2D, the contact portions 310a are exposed out of the Z′-direction face of the tongue 222a of the female main body 220a and disposed inside the female connection hole on the Z′-direction side of the tongue 222a.

The tail 320a of the female terminal 300a may preferably be exposed or protrude out of the female body 200a such as to be connectable to an external member not shown, e.g. a circuit board, terminals, a cable, etc. Particularly, the tails 320a may protrude in the Y direction out of the Y-direction end face of the female main body 220a of the female body 200a. Alternatively, the tails 320a may protrude in the Z′ direction out of the Z′-direction end face of the female main body 220a. The embodiment of FIG. 1A to FIG. 2D corresponds to the former configuration, and the tails 320a are connectable to a circuit board (not shown, hereinafter referred to as a female circuit board).

The male connector C1b may further include one of the following structure (1) to (3) for connection with the female connector C1a but not limited thereto. (1) There is provided a connection portion 130b (hereinafter referred to as a male connection portion 130b) which is detachably connectable to the female connection hole of the female connector C1a. More particularly, the male connection portion 130b may be provided in the Y-direction end of the runner 120 and extend in the Y direction beyond the male main body 110b, or may be provided in the Y-direction end of the male main body 110b and extend in the Y direction beyond the runner 120b. (2) There are provided a male connection portion 130b, which is configured as described above, and a male connection hole (hereinafter referred to as a male connection hole), which may preferably be provided on the Z- or Z′-direction side of the male connection portion 130b. (3) There is provided a male connection hole. This male connection hole is provided in the Y-direction end face of the runner 120b or of the male main body 110b and opens in the Y-direction. In the embodiment of FIGS. 1A to 1E and FIGS. 3A to 3D, there is provided a male connection portion 130b and a male connection hole. The male connection portion 130b extends in the Y direction from the Y-direction end of the runner 120b. The male connection hole is provided as a recess 13 lb in the Z-direction end of the male connection portion 130b and opens in the Z direction.

The male body 100b holds the plurality of male terminals 200b in spaced relation in the X-X′ direction. Particularly, the male terminals 200b may be insert-molded inside the male body 100b in spaced relation in the X-X′ direction. Alternatively, the male body 100b may have a plurality of holding grooves 140b spaced from each other in the X-X′ direction. In this case, the male terminals 200b are securely press-fitted in the respective holding grooves 140b of the male body 100b.

The holding grooves 140b may have one of the following configurations (1) to (3) but not limited thereto.

(1) If the male connector C1b includes the holding grooves 140b and the male connection portion 130b, the holding grooves 140b may preferably have portions located in the male connection portion 130b and open in a direction containing a Z- or Z′- direction component.

(2) If the male connector C1b includes the holding grooves 140b, the male connection portion 130b, and the male connection hole, the holding grooves 140b may preferably have portions located in the male connection portion 130b and in communication with the male connection hole.

(3) If the male connector C1b includes the holding grooves 140b and the male connection hole, the holding grooves 140b may preferably communicate with the male connection hole.

In the embodiment of FIGS. 1A to 1E and FIGS. 3A to 3D, the holding grooves 140b extend in the male main body 110b and the runner 120b, in spaced relation in the X-X′ direction, and the holding grooves 140b have portions located in the bottom of the recess 131b (i.e. the male connection hole) of the male connection portion 130b such as to open in the Z direction and communicate with the recess 131b.

The male terminals 200b may be metal plates. The male terminals 200b each include the contact portion 210b mentioned above and a tail 220b. The contact portion 210b is a portion of the male terminal 200b and may have one of the following configurations (1) to (3) but not limited thereto.

(1) If the male connector C1b includes the male connection portion 130b, (1-1) the contact portions 210b may be exposed or protrude, in a direction containing a Z- or Z′- direction component, out of the male connection portion 130b; or alternatively (1-2) the contact portions 210b may be exposed or protrude, in a direction containing a Z- or Z′-direction component, out of portions of the holding grooves 140b of the male connection portion 130b.

(2) If the male connector C1b includes the male connection portion 130b and the male connection hole, (2-1) the contact portions 210b may be exposed or protrude, in a direction containing a Z-direction component, out of the male connection portion 130b such as to be located inside the male connection hole; or alternatively (2-2) the contact portions 210b may be exposed or protrude, in a direction containing a Z′-direction component, out of the male connection portion 130b such as to be located inside the male connection hole; or alternatively (2-3) the contact portions 210b may be exposed or protrude, in a direction containing a Z-direction component, out of portions of the holding grooves 140b of the male connection portion 130b such as to be located inside the male connection hole; or alternatively (2-4) the contact portions 210b may be exposed or protrude, in a direction containing a Z′-direction component, out of portions of the holding grooves 140b of the male connection portion 130b such as to be located inside the male connection hole.

(3) If the male connector C1b includes the male connection hole, the contact portions 210b may preferably be located inside the male connection hole.

Each tail 220b is another portion (a different portion from the contact portion 210b) of each male terminal 200b. The tails 220b may preferably protrude out of the male body 100b such as to be connectable to a circuit board Pb (hereinafter referred to as a male circuit board Pb) or an external member not shown, e.g. terminals or a cable. The male terminals 200b may each further include a base 230b. Each contact portion 210b and each tail 220b may preferably extend in different directions from each base 230b. For example, the contact portions 210b may extend in a direction containing a Y-direction component, while the tails 220b may extend in a direction containing a Y′-direction component. Alternatively, the contact portions 210b may extend in a direction containing a Y-direction component, while the tails 220b may extend in a direction containing a Z-or Z′-direction component.

In the embodiment of FIGS. 1A to 1E and FIGS. 3A to 3D, the male terminals 200b each include a contact portion 210b, a tail 220b, and a base 230b. Each contact portions 210b extends in the Y direction from the Z′-direction end of the base 230b. Each base 230b is generally of U-shape with its two legs (first and second legs) extending in the Z-direction. Each tail 220b extends in the Z direction from the end of the first or second leg of the associated base 230b.

If the male body 100b includes the holding grooves 140b, the male body 100b may further include an open portion 150b. The open portion 150b is an opening through which holding grooves 140b communicate with the outside of the male body 100b. The male terminals 200b can be detachably inserted through the open portion 150b into the associated holding grooves 140b. The male connector C1b may further include a lid 300b for closing the open portion 150b. In the embodiment of FIGS. 1A to 1D and FIGS. 3A to 3D, the open portion 150b is provided in the Z′-direction face of the male body 100b, and the lid 300b closes the open portion 150b from the Z′-direction side. The lid 300b may include a lid body 310b and an engagement piece 320b provided at the lid body 310b, and the male body 100b may further include an engagement hole 160b. In this case, it is preferable that the engagement piece 320b engage with the engagement hole 160b, and that the lid body 310b close the open portion 150b. The lid 300b may be made of a metal, a plastic material, or any other suitable material. If the lid 300b is made of a metal plate, the male connector C1b may further include an insulating sheet 400b to be disposed between the lid 300b and the male terminals 200b.

The open portion 150b may be omitted. In this case, any one of or any combination of the following configurations (1) to (3) may be adopted but not limited thereto. (1) The holding grooves 140b open to the outside of the male body 100b. (2) The lid 300b closes the holding grooves 140b. 3) The insulating sheet 400b is disposed between the lid 300b and the male terminals 200b. Irrespective of whether the open portion 150b is omitted or not, if there a low risk of the short circuit between the lid 300b and the male terminals 200b, the insulating sheet 400b can be omitted.

The female connector C1a may further include a pair of covers 130a, namely an X-direction-side cover 130a and an X′-direction-side cover 130a. The pair of support portions 120a is comprised of an X-direction-side support portion 120a and an X′-direction-side support portion 120a. The X-direction-side cover 130a extends in the X′ direction from the X-direction-side support portion 120a. The X′-direction-side cover 130a extends in the X direction from the X′-direction-side support portion 120a. The covers 130a may preferably have at least one of the following configurations (4) and (5). (4) The covers 130a cover the female body 200a from the Z-direction side. (5) The covers 130a abuts the female body 200a from the Z-direction side. In case (5), the covers 130a function as a pair of second abutment portions as defined in the claims. The opposing ends of the covers 130a may be opposed to each other with a clearance therebetween or in contact with each other. The covers 130a may be coupled to each other. In the configuration as shown in FIG. 1A to FIG. 2D, the covers 130a have the configurations (4) and (5), and the opposing ends of the covers 130a are in contact with each other.

The guide 110a of the female connector C1a may further include at least one bottom 112a. The or each bottom 112a may be provided between and couple together the associated pair of rails 111a of the frame of the guide 110a. Alternatively, the or each bottom 112a may be the bottom of the associated rail groove of the guide 110a, and be provided between the rails 111a of the rail groove. The at least one bottom 112a may extend in the Y-Y′ direction. Alternatively, a plurality of bottoms 112a may be arranged in spaced relation in the Y-Y′ direction. The at least one bottom 112a may preferably be located on the Z′-direction side relative to the contact portions 310a of the female terminals 300a. In the embodiment of FIG. 1A to FIG. 2D, there is one bottom 112a extending in the Y-Y′ direction and coupling between the rails 111a of the frame of the guide 110a.

The one or each bottom 112a may have an opening 113a passing in the Z-Z′ direction through the Y-direction-side end portion of the bottom 112a. The or each opening 113a may be located on the Z′-direction side of the female connection portion of the female connector C1a as shown in FIG. 1A to FIG. 2D, or on the Y′-direction side relative to the female connection portion of the female connector C1a. The opening 113a may be omitted.

One of the following configurations (1) to (3) may be adopted but not limited thereto.

(1) If the female connector C1a includes the guide 110a being a frame having a pair of rails 111a and a bottom 112a and also includes a pair of support portions 120a, then the rails 111a, the bottom 112a, and the support portions 120a may be formed as a single integral member, such as a sheet metal, a metal member, or a plastic member.

(2) If the female connector C1a includes the guide 110a being a frame having a pair of rails 111a and also includes a pair of support portions 120a and covers 130a, then the rails 111a, the support portions 120a, and the covers 130a may be formed as a single integral member, such as a sheet metal, a metal member, or a plastic member. In this case, the covers 130a may preferably be coupled to each other.

(3) If the female connector C1a includes the guide 110a being a frame having a pair of rails 111a and a bottom 112a and also includes a pair of support portions 120a and a pair of covers 130a, then the rails 111a, the bottom 112a, the support portions 120a, and the covers 130a may be formed as a single integral member, such as a sheet metal, a metal member, or a plastic member.

In the embodiment of FIG. 1A to FIG. 2D, the rails 111a of the frame, the bottom 112a of the frame, the support portions 120a, and the covers 130a are formed as a single sheet metal. As discussed above, the covers 130a and/or the bottom 112a may be omitted.

The female connector C1a may further include a female biasing portion 500a. The female biasing portion 500a is only required to be fixed to the at least one bottom 112a to bias the male connector C1b to the Z-direction side when the male connector C1b is guided by the guide 110a. The female biasing portion 500a may be a plate spring, a coil spring, a rubber, or any other elastic body that is fixed to the at least one bottom 112a. For example, as in the embodiment of FIG. 1A to FIG. 2D, the female biasing portion 500a may include an engagement arm 510a, a pair of biasing arms 520a, and a base 530a. The engagement arm 510a extends in the Y direction from the center of the base 530a. The biasing arms 520a extend in the Y direction from ends in the X-X′ direction of the base 530a. The bottom 112a of the guide 110a is provided with an engagement portion 114a and a pair of cutouts 115a. The engagement portion 114a has an insertion hole and a bridge. The insertion hole of the engagement portion 114a passes in the Z-Z′ direction through the bottom 112a. The bridge of the engagement portion 114a bridges between the X- and X′-direction edges of the insertion hole. The engagement arm 510a is received in the insertion hole from the Z′-direction side of the bottom 112a and engages with the bridge from the Z-direction side. The base 530a abuts the bottom 112a from the Z′-direction side. The cutouts 115a pass through the bottom 112a in the Z-Z′ direction. Distal ends of the biasing arms 520a are placed through the respective cutouts 115a and into the guide 110a from the Z′-direction side.

The female biasing portion 500a can bias the male connector C1b in the Z direction so as to bring the contact portions 210b of the male terminals 200b of the male connector C1b into elastic contact with the associated contact portions 310a of the female terminals 300a of the female connector C1a in any of the following cases (1) to (3): (1) the contact portions 210b are exposed or protrude in the Z direction out of the male connection portion 130b, and the contact portions 310a are exposed or protrude in the Z′ direction out of the female connection portion; (2) the contact portions 210b of are located in the male connection hole, and the contact portions 310a are exposed or protrude in the Z′ direction out of the female connection portion; or (3) the contact portions 210b are exposed or protrude in the Z direction out of the male connection portion 130b, and the contact portions 310a are located in the female connection hole.

If the female connector C1a includes the covers 130a to abut the female body 200a from the Z-direction side, the female biasing portion 500a biases the male connector C1b in the Z direction and thereby presses the male connector C1b and the female body 200a onto the covers 130a. In other words, the male connector C1b and the female body 200a are elastically held by and between the covers 130a and the female biasing portion 500a. This arrangement suppresses backlash in the Z-Z′ direction of the male connector C1b when located in the connection position.

The guide 110a of the female connector C1a may include a pair of first abutment portions 111a1. The first abutment portions 111a1 is only required to be abuttable from the Z′-direction side by the runner 120b of the male connector C1b biased in the Z direction by the female biasing portion 500a. Particularly, the first abutment portions 111a1 may have one of the following configurations (1) to (3) but not limited thereto. (1) The first abutment portions 111a1 are bent portions of the guide 110a bent such that the rails 111a of the frame of the guide 110a come closer to each other, and the bent portions are located on the Z-direction side relative to the runner 120b. (2) The first abutment portions are elongate protrusions on the rails 111a of the frame of the guide 110a, protrude in directions closer to each other, and are located on the Z-direction side relative to the runner 120b. (3) The first abutment portions 111a1 are elongate projections extending along the rails 111a of the rail grooves of the guide 110a, protrude in directions closer to each other, and are located on the Z-direction side relative to the runner 120b. In the embodiment of FIG. 1A to FIG. 2D, the first abutment portions 111a1 are the bent portions. In any configuration (1) to (3) of the first abutment portions 111a1, the biasing force of the female biasing portion 500a presses the runner 120b of the male connector C1b onto the first abutment portions 111a1. In other words, the male connector C1b is elastically held by and between the first abutment portions 111a1 and the female biasing portion 500a. This arrangement suppresses backlash in the Z-Z′ direction of the male connector C1b when located in the connection position. It should be noted that the female connector C1a may include the first abutment portions 111a1 only, or the second biasing portions only, or both the first and second abutment portions, or neither the first abutment portions 111a1 nor the second biasing portions.

The guide 110a of the female connector C1a may further include a female engagement portion 116a. The female engagement portion 116a may preferably be an engagement hole that is provided in the guide 110a and extends in the X-X′ direction. In the embodiment of FIG. 1A to FIG. 2D, the female engagement portion 116a is an engagement hole passing in the X-X′ direction through the rails 111a on the X′-direction side.

The male connector C1b may further include a male engagement portion 500b and a male biasing portion 600b. The male engagement portion 500b is an engagement block. The male biasing portion 600b is an elastic body, such as a coil spring or a rubber. The male body 100b of the male connector C1b may further include an accommodation portion 170b. The accommodation portion 170b may preferably be a recess extending in the X-X′ direction in the male body 100b and opening such as to communicate with the female engagement portion 116a when the male connector C1b is in the connection position. The male engagement portion 500b is accommodated in the accommodation portion 170b such as to be movable in the X-X′ direction. The male biasing portion 600b is disposed in the accommodation portion 170b, particularly between a wall of the accommodation portion 170b and the male engagement portion 500b, and biases the male engagement portion 500b in one of the X and X′ directions (the X′ direction in the embodiment of FIGS. 1A to 1E and FIGS. 3A to 3D). The male engagement portion 500b may have a tapered face 510b. In this case, when the runner 120b of the male connector C1b is guided by the guide 110a of the female connector C1a, the tapered face 510b abuts on one of the first abutment portions 111a1 of the guide 110a, allowing the male engagement portion 500b to move in the other of the X and X′ directions (the X direction in the embodiment of FIGS. 1A to 1E and FIGS. 3A to 3D) against a biasing force of the male biasing portion 600b. Alternatively, when the runner 120b of the male connector C1b is guided by the guide 110a of the female connector C1a, a user may manually move the male engagement portion 500b in the other of the X and X′ against the biasing force of the male biasing portion 600b. In either case, when the male connector C1b guided by the guide 110a has moved to the connection position, the accommodation portion 170b of the male connector C1b communicates with the female engagement portion 116a of the female connector C1a. Then the male engagement portion 500b, subjected to a biasing force of the male biasing portion 600b, is inserted into and engaged with the female engagement portion 116a. An edge of the opening of the accommodation portion 170b may be provided with a restricting portion configured to abut on a portion of the male engagement portion 500b and thereby restrict the male engagement portion 500b to move in the X or X′ direction beyond the specified range.

The male connector C1b may further include a fixation member 700b and a pin or screw 800b. The fixation member 700b is fixed to the male body 100b such as to at least partially cover the male engagement portion 500b and the male biasing portion 600b from the Z-direction side. The pin or screw 800b fixes the fixation member 700b to the male body 100b. In the embodiment of FIGS. 1A to 1E and FIGS. 3A to 3D, the fixation member 700b has a generally of U-shaped cross-section in the Z-Z′ direction, with its two legs respectively received in slits in the male body 100b. The pin or screw 800b extends through the fixation member 700b and fittingly or threadedly engaged with a hole of the male body 100b.

The female engagement portion 116a and the male engagement portion 500b may be configured as described above or as described below. One of the female engagement portion 116a and the male engagement portion 500b may be an engagement hole, and the other may be an engagement protrusion. The engagement protrusion may preferably engages with the engagement hole when the male connector C1b is in the connection position. In this case, the male biasing portion 600b may be omitted. If there is no need to fix the male connector C1b in position with respect to the female connector C1a when the male connector C1b is in the connection position, it is then possible to omit the female engagement portion 116a, the male biasing portion 600b, and the male biasing portion 600b.

The female connector C1a as shown in FIG. 1A to FIG. 2D may be fabricated in the following steps. First, a sheet metal is pressed into form. Particularly, the pair of rails 111a of the guide 110a and the pair of support portions 120a contiguous with the rails 111a are bend relative to the bottom 112a such as to extend in the Z direction, and the cover 130a on the X-direction side is bent relative the support portion 120a on the X-direction side such as to extend in the X′ direction, and the cover 130a on the X′-direction side is bent relative to the support portion 120a on the X′-direction side such as to extend in the X direction. Also, the plurality of female terminals 300a are prepared and insert-molded into the female body 200a. The female terminals 300a are thus held in the female body 200a, in spaced relation from each other in the X-X′ direction. The shaft 400a is also prepared. The female body 200a is disposed between the support portions 120a and in contact with the covers 130a, so that the through hole 211a of the female body 200a communicate with the support holes 121a of the support portions 120a. In this state, the shaft 400a is inserted into the support holes 121a of the support portions 120a and the through hole 211a of the female body 200a. As a result, the female body 200a and the female terminals 300a held therein are supported by the shaft 400a such as to be floatable along the X-X′ direction between the support portions 120a. Then, the female biasing portion 500a is prepared. The engagement arm 510a of the female biasing portion 500a is brought into engagement with the engagement portion 114a of the bottom 112a, and the distal ends of the pair of biasing arms 520a of the female biasing portion 500a are inserted from the Z′-direction side through the respective cutouts 115a of the bottom 112a and then into the guide 110a. The female connector C1a has thus been fabricated. Then, the tails 320a of the female terminals 300a are connected to a female circuit board. The face on the Z′-direction side of the bottom 112a of the female connector C1a may be fixed to a case (not shown, hereinafter referred to as a female case). The female case may preferably have an opening to accommodate the female circuit board. The female case may also accommodate at least one electronic component mounted or connected to the female circuit board.

The male connector C1b as shown in FIGS. 1A to 1E and FIGS. 3A to 3D may be fabricated in the following steps. First, the male body 100b is molded from a plastic material. The male body 100b is molded together with the runner 120b. The male terminals 200b are prepared. The male terminals 200b are placed through the open portion 150b of the male body 100b into the associated holding grooves 140b. Accordingly, the tails 220b of the male terminals 200b protrude in the Z direction out of the holding grooves 140b, and the distal ends of the contact portions 310a of the male terminals 200b protrude out of the holding grooves 140b such as to be located inside the recess 131b of the male connection portion 130b. The insulating sheet 400b is also prepared. The insulating sheet 400b is inserted into the open portion 150b of the male body 100b so as to cover the male terminals 200b. The lid 300b is also prepared. The engagement piece 320b of the lid 300b is inserted for engagement into the engagement hole 160b of the male body 100b, and the lid body 310b of the lid 300b closes the open portion 150b. Also, the male engagement portion 500b and the male biasing portion 600b are prepared and placed into the accommodation portion 170b of the male body 100b. At this time, the male biasing portion 600b is disposed between the male engagement portion 500b and the wall on the X-direction side of the accommodation portion 170b. The male biasing portion 600b thus biases the male engagement portion 500b in the X′ direction. The fixation member 700b is also prepared. The legs of the fixation member 700b are respectively inserted the slits of the male body 100b. The fixation member 700b thus covers the male engagement portion 500b and the male biasing portion 600b partially from the Z-direction side. The pin or screw 800b is also prepared. The pin or screw 800b is used to fasten the fixation member 700b to the male body 100b. The male connector C1b has thus been fabricated. Then, the tails 220b of the male terminals 200b are connected to the male circuit board Pb. The male body 100b of the male connector C1b may be fixed to a case (not shown, hereinafter referred to as a male case). If the male case is provided, located outside of the male case are the runner 120b, the Z′-direction end portion of the male body 100b, and the Z′-direction end portion of the male biasing portion 600b. The male case may accommodate the male circuit board Pb and at least one electronic component mounted or connected thereto.

The male connector C1b and the female connector C1a fabricated as described above may be connected to each other in the following steps. The runner 120b of the male connector C1b is inserted in between the rails 111a of the guide 110a of the female connector C1a, and the runner 120b is then moved in the Y-Y′ direction from the initial position to the connection position in such a manner to be floatable in the X-X′ direction between the rails 111a. During the movement of the runner 120b, the tapered face 510b of the male engagement portion 500b of the male connector C1b is pressed onto the first abutment portion 111a1 of the X′-direction-side rail 111a of the female connector C1a. This pressing force moves the male engagement portion 500b in the X direction against the biasing force of the male biasing portion 600b. On the other hand, the biasing arms 520a of the female biasing portion 500a of the female connector C1a bias the male connector C1b in the Z direction. This biasing force brings the runner 120b of the male connector C1b into abutment with the first abutment portions 111a1 of the rails 111a of the female connector C1a from the Z′-direction side. Once the male connector C1b is placed in the connection position, the accommodation portion 170b of the male connector C1b communicates with the female engagement portion 116a of the female connector C1a, and the male engagement portion 500b is moved in the X′ direction by the biasing force of the male biasing portion 600b and brought into engagement with the female engagement portion 116a. Simultaneously, the male connection portion 130b of the male connector C1b is received into the female connection hole of the female connector C1a, and the tongue 222a (female connection portion) of the female connector C1a is received into the recess 131b (male connection hole) of the male connection portion 130b of the male connector C1b. In this arrangement in which the male connector C1b is biased by the female biasing portion 500a, the contact portions 210b of the male terminals 200b protruding in the Z direction out of the male connection portion 130b are brought into elastic contact with the contact portions 310a of the female terminals 300a, which are exposed in the Z′ direction out of the tongue 222a of the female connector C1a. This establishes electrical connection between the male connector C1b and the female connector C1a, i.e. completes the assembly of the connection structure S1 of the male connector C1b and the female connector C1a.

The connection structure S1 described above has at least the following technical features. First, the connection structure S1 has a reduced number of components for the floating structure of the female connector C1a because of a simple configuration (1) or (2). (1) The shaft 400a is received in the support holes 121a of the support portions 120a and the at least one through hole 211a of the female body 200a, such that the female body 200a is supported by and between the support portions 120a such as to be floatable along the X-X′ direction. (2) Alternatively, the shaft 400a is fixed to the female body 200a such as to extend in the X-X′ direction through at least a portion of the female body 200a and is received in the support holes 121a of the support portions 120a such as to be floatable along the X-X′ direction.

Second, if including the covers 130a and the bottom 112a, the female connector C1a reduces the risk that a user may touch the contact portions 310a of the female terminals 300a. This is because the covers 130a of the female connector C1a cover the female body 200a from the Z-direction side, and because, although the contact portions 310a of the female terminals 300a are exposed in the Z′-direction out of the tongue 222a of the female body 200a, the bottom 112a of the guide 110a of the female connector C1a is located on the Z′-direction side relative to the contact portions 310a.

Third, if the female connector C1a includes the covers 130a and/or the guide 110a with the first abutment portions 111a1, the connection structure S1 minimizes backlash in the Z-Z′ direction of the male connector C1b at the connection position so as to stabilize the connection between the female connector C1a and the male connector C1b. The reason for this is as follows. When the runner 120b of the male connector C1b is guided by the guide 110a and has moved to the connection position, the male connector C1b is biased in the Z direction by the female biasing portion 500a of the female connector C1a. Due to this biasing force, the runner 120b of the male connector C1b is brought into abutment, from the Z′-direction side, with the first abutment portions 111a1 of the female connector C1a; and/or the contact portions 210b of the male terminals 200b of the male connector C1b are brought into elastic contact, from the Z′-direction side, with the contact portions 310a of the female terminals 300a of the female connector C1a. In other words, the male connector C1b is elastically held in the Z-Z′ direction by and between the female biasing portion 500a and the first abutment portions 111a1 of the female connector C1a, and/or the male connector C1b and the female body 200a are elastically held in the Z-Z′ direction by and between the female biasing portion 500a and the covers 130a. This arrangement reduces backlash in the Z-Z′ direction of the male connector C1b in the connection position and thereby stabilizes the connection between the female connector C1a and the male connector C1b.

Fourth, if the guide 110a of the female connector C1a includes the bottom 112a with the opening 113a, the connection structure S1 is suitably configured for readily removing unwanted materials (e.g. dust, lint, dirt, etc.) accumulated on the bottom 112a of the guide 110a. Particularly, when the runner 120b of the male connector C1b is guided by the rails 111a of the guide 110a, the runner 120b pushes unwanted materials on the bottom 112a outwardly in the Y direction and eject them through the opening 113a of the bottom 112a.

Fifth, if the male connector C1b includes the male body 100b with the accommodation portion 170b, the male engagement portion 500b, and the male biasing portion 600b, and if the guide 110a of the female connector C1a includes the female engagement portion 116a, the connection structure S1 provides an automatic mechanism by which the male connector C1b in the connection position is securely positioned relative to the female connector C1a. This is because, in the connection position, the accommodation portion 170b of the male connector C1b communicates with the female engagement portion 116a of the female connector C1a, and the male engagement portion 500b biased by the male biasing portion 600b is engaged with the female engagement portion 116a.

Sixth, if the guide 110a of the female connector C1a, the support portions 120a, and the covers 130a are formed of a sheet metal, and the shaft 400a is made of metal, the connection structure S1 has improved resistance against load imposed when the runner 120b of the male connector C1b is twisted inside the guide 110a of the female connector C1a.

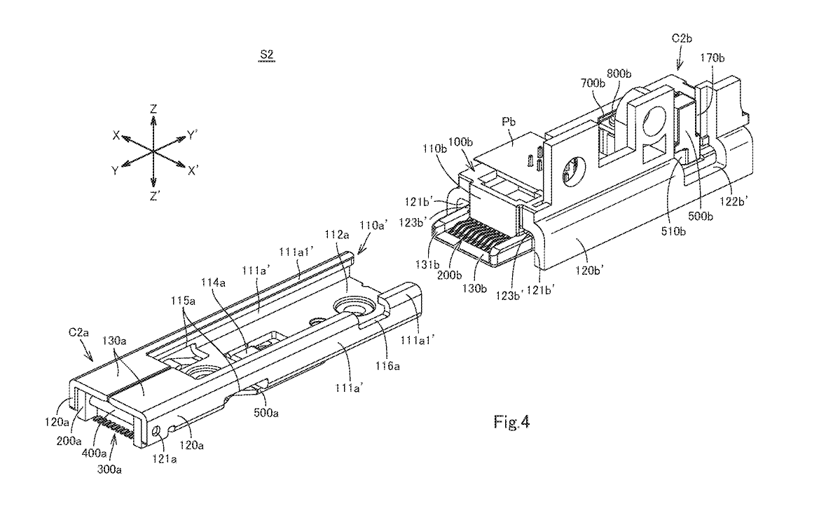

A connection structure S2 according to some other embodiments of the invention will be described below in detail with reference to FIG. 4. FIG. 4 shows an embodiment (hereinafter referred to as the second embodiment) of the connection structure S2. The connection structure S2 includes a female connector C2a and a male connector C2b. The Y-Y′ direction, the X-X′ direction, and the Z-Z′ direction are defined as shown in FIG. 4, in the same manner as in the first embodiment.

The male connector C2b has the same configuration as that of the male connector C1b, except that the male connector C2b includes a runner 120b′ of different configuration from that of the runner 120b of the male connector C1b. The difference will be described below in detail, and redundant descriptions of the male connector C2b will not be repeated.

Preferably, the runner 120b′ may be of any configuration as long as it can be guided movably in the Y-Y′ direction by a guide 110a′ (to be described) of the female connector C2a such as to be floatable along the X-X′ direction. For example, the runner 120b′ may include at least one runner groove 121b′ extending in the Y-Y′ direction. The runner 120b′ may be integrally provided at any suitable position of the male main body 110b. Alternatively, the runner 120b′ may be formed separately from the male main body 110b and fixed to any suitable position of the male main body 110b.

In the embodiment of FIG. 4, the runner 120b′ is a rectangular plate extending in the X-X′ and Y-Y′ directions and being integral with the Z′-direction end of the male main body 110b. The runner 120b′ has a pair of runner grooves 121b′, the length of which extends in the Y-Y′ direction in spaced relation to each other in the X-X′ direction. The runner grooves 121b′ are symmetrically shaped in the X-X′ direction, rising in the Z direction and then curves in directions closer to each other.

The female connector C2a has the same configuration as that of the female connector C1a, except that the female connector C2a includes a guide 110a′ of different configuration from that of the guide 110a of the female connector C1a. The difference will be described below in detail, and redundant descriptions of the female connector C2a in this embodiment will not be repeated.

The guide 110a′ of the female connector C2a extends in the Y-Y′ direction. The guide 110a′ includes at least one rail 111a′ extending in the Y-Y′ direction. The or each rail 111a′ may be of any configuration as long as it is receivable in the associated runner groove 121b′ of the runner 120b′ of the male connector C2b with clearance in the X-X′ direction and movable in the Y-Y′ direction in and along the associated runner groove 121b′. More specifically, the or each rail 111a′ may preferably have an X-X′ direction dimension that is slightly smaller than that of the or each runner groove 121b′ of the runner 120b′.

The female connector C2a as shown in FIG. 4 has substantially the same configuration as that of the female connector C1a as shown in FIG. 1A to FIG. 2D. The differences are that the guide 110a′ of the female connector C2a includes a pair of rails 111a′of shape corresponding to the pair of runner grooves 121b′, and the rails 111a′ are received in the associated runner grooves 121b′ with clearance in the X-X′ direction and movable in the Y-Y′ direction in and along the runner grooves 121b′. The pair of rails 111a′ may or may not include first abutment portions 111a1′, which may be bent portions.

The guide 110a′ may include three or more rails 111a′, and the runner 120b′ may accordingly include three or more runner grooves 121b′.

The support portions 120a are provided on the Y-direction side relative to the guide 110a′ and are spaced from each other in the X-X′ direction. For example, the support portions 120a may extend in the Y direction from the respective Y-direction ends of the pair of rails 111a′ of the guide 110a′. For further details of the support portions 120a, reference should be made to the support portions 120a of the female connector C1a described above.

The guide 110a′ of the female connector C2a may further include at least one bottom 112a. The bottom 112a may be may be provided between and couple together the pair of rails 111a′ of the guide 110a′. For further details of the bottom 112a, reference should be made to the bottom 112a of the female connector C1a described above.

If the female connector C2a includes the guide 110a′ having the rails 111a′ with the first abutment portions 111a1′ and further includes the female biasing portion 500a, the runner 120b′ of the male connector C2b may further include flanges 123b′ extending along the edges of the runner grooves 121b′. The flanges 123b′ are located on the Z′-direction side relative to the first abutment portions 111a1′ when the rails 111a′ are received in the runner grooves 121b′. When the male connector C2b is biased in the Z-direction by the female biasing portion 500a, the flanges 123b′ of the runner 120b′ abut on the first abutment portions 111a1′ from the Z′-direction side.

If the male connector C2b further includes the male engagement portion 500b and the male biasing portion 600b, the male connector C2b is configured as follows. One of the runner grooves 121b′ (the runner groove 121b′ on the X′-direction side in the embodiment of FIG. 4) of the runner 120b′ communicates with the accommodation portion 170b of the male body 100b. The male engagement portion 500b of the male connector C2b has a tapered face 510b, which is located in the one of the runner grooves 121b′ and is configured to be pressed onto one of the first abutment portions 111a1′ of the pair of rails 111a′. The runner 120b′ may preferably be provided with a cutout 122b′ that allows the male engagement portion 500b to move in the X-X′ direction. The cutout 122b′ communicates with the one of the runner grooves 121b′ and the accommodation portion 170b.

The female connector C2a as shown in FIG. 4 may be fabricated in the same manner as the female connector C1a as shown in FIGS. 1A to FIG. 2D. The male connector C2b as shown in FIG. 4 may be fabricated in the same manner as the male connector C1b as shown in FIGS. 1A to 1E and FIGS. 3A to 3D, except that the male body 100b of the male connector C2b is molded from plastic material together with the runner 120b′ in place of the runner 120b.

The male connector C2b and the female connector C2a fabricated as described above may be connected to each other in the following steps. The rails 111a′ of the guide 110a′ of the female connector C2a are respectively inserted into the runner grooves 121b′ of the runner 120b′ of the male connector C2b, and the runner 120b′ is moved along the rails 111a′ from the initial position to the connection position is such a manner as to be floatable along the X-X′ direction. During the movement of the runner 120b′, the tapered face 510b of the male engagement portion 500b of the male connector C2b is pressed, inside the runner groove 121b′ on the X′-direction side, onto the first abutment portion 111a1′ of the X′-direction side rail 111a′of the female connector C2a. This pressing force moves the male engagement portion 500b in the X direction against the biasing force of the male biasing portion 600b. On the other hand, the biasing arms 520a of the female biasing portion 500a of the female connector C2a bias the male connector C2b in the Z direction. This biasing force brings the flanges 123b′ of the runner grooves 121b′ of the runner 120b′ of the male connector C2b into abutment with the associated first abutment portions 111a1′ of the rails 111a′ of the female connector C2a from the Z′-direction side. Once the male connector C2b is placed in the connection position, the accommodation portion 170b of the male connector C2b communicates with the female engagement portion 116a of the female connector C2a, and the male engagement portion 500b is moved in the X′ direction by the biasing force of the male biasing portion 600b and brought into engagement with the female engagement portion 116a. Simultaneously, the male connection portion 130b of the male connector C2b is received into the female connection hole of the female connector C2a, and the tongue 222a (female connection portion) of the female connector C2a is received into the recess 13 lb (male connection hole) of the male connection portion 130b of the male connector C2b. In this arrangement in which the male connector C2b is biased by the female biasing portion 500a, the contact portions 210b of the male terminals 200b protruding in the Z direction out of the male connection portion 130b are brought into elastic contact with the contact portions 310a of the female terminals 300a exposed in the Z′ direction out of the tongue 222a of the female body 200a of the female connector C2a. This establishes electrical connection between the male connector C2b and the female connector C2a, i.e. completes the assembly of the connection structure S2 of the male connector C2b and the female connector C2a.

The connection structure S2 described above has at least the first to sixth technical features described in connection with the connection structure S1.

The connection structure, the female connector, and the male connector described above are not limited to the above embodiments but can be modified in any manner within the scope of the claims. Specific modifications will be described below.

The floating structure of the female connector of any aspect described above may be modified to any structure described below. A female body 200a′ is disposed between a pair of support portions 120a′. The female body 200a′ may include a female main body 220a′, and at least one opposing portion 230a′ opposed to the pair of support portions 120a′. The at least one opposing portion 230a′ may be part of the female main body 220a′, may extend from the female main body 220a′, or may be fixed to the female main body 220a′.

More specifically, the floating structure may have one of the following configurations (1) to (4):

(1) The female body 200a′ includes one opposing portion 230a′, and a pair of shaft parts 410a′ is provided. One of the shaft parts 410a′ extends in the X direction from the X-direction end face of the opposing portion 230a′ to be received in a support hole 420a′ of the support portion 120a′ on the X-direction side such as to be floatable along the X-X′ direction. The other shaft part 410a′ extends in the X′ direction from the X′-direction end face of the opposing portion 230a′ to be received in a support hole 420a′ of the support portion 120a′ on the X′ direction side such as to be floatable along the X-X′ direction.

(2) The female body 200a′ includes one opposing portion 230a′, the opposing portion 230a′ has at least one support hole 420a′ extending in the X-X′ direction, and a pair of shaft parts 410a′ is provided. One of the shaft parts 410a′ extends in the X′ direction from the support portion 120a′ on the X-direction side to be received in a support hole 420a′ such as to be floatable along the X-X′ direction. The other shaft part 410a′ extends in the X direction from the support portion 120a′ on the X′-direction side to be received in the or another support hole 420a′ such as to be floatable along the X-X′ direction.

(3) The female body 200a′ includes a pair of opposing portions 230a′, and a pair of shaft parts 410a′ is provided. The shaft parts 410a′ extends respectively from the opposing portions 230a′, and the pair of support portions 120a is provided with a pair of support hole 420a′ to receive the shaft parts 410a′ in a floatable manner in the X-X′ direction.

(4) The female body 200a′ includes a pair of opposing portions 230a′, and a pair of shaft parts 410a′ is provided. The shaft parts 410a′ extends respectively from the pair of support portions 120a, and the pair of opposing portions 230a′ is provided with a pair of support hole 420a′ to receive the shaft parts 410a′ in a floatable manner in the X-X′ direction.

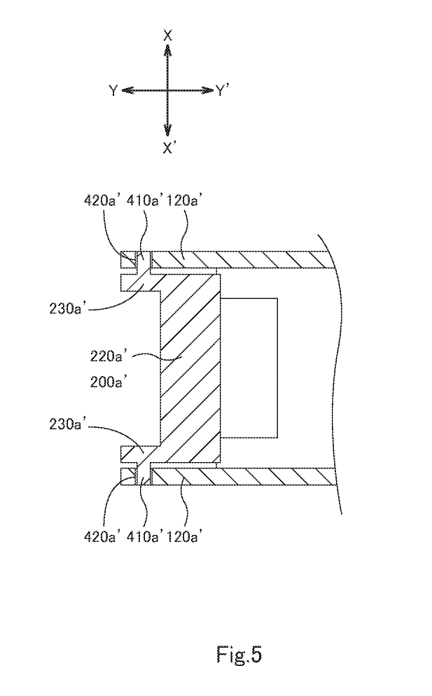

In the embodiment of FIG. 5, the female body 200a′ includes a pair of opposing portions 230a′ extending in the Y direction from the X- and X′-direction ends of the Y-direction end face of the female main body 220a′, and a pair of shaft parts 410a′ extends in the X- and X′ directions, respectively, from the opposing portions 230a to be received in associated support holes 420a′ of the pair of support portions 120a such that the shaft parts 410a′ are floatable along the X-X′ direction. In FIG. 5, the female terminals 300a are not shown for convenience of illustration, and the Y-Y′ and X-X′ directions are defined as in the first embodiment. As described above, the shaft parts 410a′ in this embodiment are supported in the support holes 420a′ such as to be floatable along the X-X′ direction, so that the female body 200a′ and the female terminals 300a are supported between the support portions 120a′ such as to be floatable along the X-X′ direction. Including a floating structure of any aspect described above, the female connector of the invention may have any configuration described above. Further, the/or each shaft part 410a′ may be a metal shaft. The support portions 120a′ may be part of a metal plate.

The female body of any aspect described above may be covered with a shield case. The male body of any aspect described above may be also covered with a shield case. In this case, the runner may be part of the shield case.

It should be appreciated that the above embodiments and variants of the connection structure and the female and male connectors are described above by way of examples only. The materials, shapes, dimensions, numbers, arrangements, and other configurations of the constituents of the connection structure and the female and male connectors may be modified in any manner if they can perform similar functions. The configurations of the embodiments and the variants described above may be combined in any possible manner. The first direction of the invention may be any direction in which the guide guides the male connector. The second direction of the invention may be any direction orthogonal to the first direction of the invention. The third direction of the invention may be any direction orthogonal to the first and second directions of the invention.

The entire contents of all references cited in this disclosure are incorporated herein in their entireties, by reference. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether such ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

### REFERENCE SIGNS LIST

S1: Connection structure

C1a: Female connector

110a: Guide

111a: Rail

111a1: First contact portion

112a: Bottom

113a: Opening

120a: Support portion

121a: Support hole

130a: Cover (Second contact portion)

200a: Female body

210a: Wing

211a: Through hole

220a: Female main body

221a: Base

222a: Tongue

300a: Female terminal

310a: Contact portion

320a: Tail

400a: Shaft

500a: Female biasing portion

510a: Engagement arm

520a: Biasing arm

530a: Base

C1b: Male connector

100b: Male body

110b: Male main body

120b: Runner

130b: Male connection portion

131b: Recess (Male connection hole)

140b: Holding groove

150b: Opening portion

160b: Engagement hole

170b: Accommodation portion

200b: Male terminal

210b: Contact portion

220b: Tail

230b: Base

300b: Lid

310b: Lid body

320b: Engagement piece

400b: Insulating sheet

500b: Male engagement portion

600b: Male biasing portion

700b: Fixation member

800b: Pin or screw

S2: Connection structure

C2a: Female connector

110a′: Guide

111a′: Rail

111a′: First contact portion

C2b: Male connector

120b′: Runner

121b′: Runner groove

122b′: Cutout

123b′: Flange

What is claimed is:

1. A female connector for mating with a male connector, the female connector comprising:
a guide extending in a first direction, the guide being configured to guide the male connector in the first direction such that the male connector is floatable along a second direction, the second direction being orthogonal to the first direction;
a pair of support portions on one side in the first direction relative to the guide, the support portions being spaced from each other in the second direction and each having a support hole passing therethrough in the second direction;
a female body being insulative and disposed between the support portions, the female body having a through hole passing in the second direction through at least a portion in the second direction of the female body;
a female terminal held in the female body; and
a shaft received in the support holes of the support portions and the through hole of the female body so as to support the female body floatably along the second direction.

2. A female connector for mating with a male connector, the female connector comprising:
a guide extending in a first direction, the guide being configured to guide the male connector in the first direction such that the male connector is floatable along a second direction, the second direction being orthogonal to the first direction;
a pair of support portions on one side in the first direction relative to the guide, the support portions being spaced from each other in the second direction and each having a support hole passing therethrough in the second direction;
a female body being insulative and disposed between the support portions;
a female terminal held in the female body; and
a shaft extending in the second direction through at least a portion in the second direction of the female body, being fixed to the female body, and being received in the support holes of the support portions such as to be floatable along the second direction.

3. A female connector for mating with a male connector, the female connector comprising:
a guide extending in a first direction, the guide being configured to guide the male connector in the first direction such that the male connector is floatable along a second direction, the second direction being orthogonal to the first direction;
a pair of support portions on one side in the first direction relative to the guide, the support portions being spaced from each other in the second direction;
a female body being insulative and disposed between the support portions, the female body including at least one opposing portion facing the support portions; and
a female terminal held in the female body, wherein
the opposing portion includes a shaft part extending in the second direction and the support portions have a support hole receiving the shaft part such that the shaft part is floatable along the second direction, or alternatively the support portions include a shaft part extending in the second direction and the opposing portion has a support hole receiving the shaft part such that the shaft part is floatable along the second direction.

4. The female connector according to claim 1, wherein
the guide includes a pair of rails extending in the first direction, and
the rails are configured to guide a runner of the male connector in the first direction, with the runner being received between the rails with a clearance in the second direction.

5. The female connector according to claim 2, wherein
the guide includes a pair of rails extending in the first direction, and
the rails are configured to guide a runner of the male connector in the first direction, with the runner being received between the rails with a clearance in the second direction.

6. The female connector according to claim 1, wherein
the guide includes at least one rail extending in the first direction, and
the rail is configured to guide the male connector in the first direction, with the rail being received, with a clearance in the second direction, in a runner groove of a runner of the male connector.

7. The female connector according to claim 2, wherein
the guide includes at least one rail extending in the first direction, and
the rail is configured to guide the male connector in the first direction, with the rail being received, with a clearance in the second direction, in a runner groove of a runner of the male connector.

8. The female connector according to claim 4, further comprising
a pair of covers extending from the respective support portions such as to cover the female body from one side in a third direction, the third direction being orthogonal to the first and second directions, wherein
the female terminal includes a contact portion exposed to the other side in the third direction out of the female body,
the guide further includes a bottom between the rails, and
the bottom is located on the other side in the third direction relative to the contact portion of the female terminal.

9. The female connector according to claim 5, further comprising
a pair of covers extending from the respective support portions such as to cover the female body from one side in a third direction, the third direction being orthogonal to the first and second directions, wherein
the female terminal includes a contact portion exposed to the other side in the third direction out of the female body,
the guide further includes a bottom between the rails, and
the bottom is located on the other side in the third direction relative to the contact portion of the female terminal.

10. The female connector according to claim 1, wherein
the guide includes a pair of first abutment portions, and
the female connector further comprises a female biasing portion, the female biasing portion being provided at the guide such as to bias the male connector to one side in a third direction to bring the male connector into abutment with the first abutment portions, the third direction being orthogonal to the first and second directions.

11. The female connector according to claim 2, wherein
the guide includes a pair of first abutment portions, and
the female connector further comprises a female biasing portion, the female biasing portion being provided at the guide such as to bias the male connector to one side in a third direction to bring the male connector into abutment with the first abutment portions, the third direction being orthogonal to the first and second directions.

12. The female connector according to claim 1, further comprising:
a pair of second abutment portions extending from the respective support portions and abutting the female body from one side in a third direction, the third direction being orthogonal to the first and second directions; and
a female biasing portion provided at the guide such as to bias the male connector to the one side in the third direction to bring a male terminal of the male connector into elastic contact with the female terminal.

13. The female connector according to claim 2, further comprising:
a pair of second abutment portions extending from the respective support portions and abutting the female body from one side in a third direction, the third direction being orthogonal to the first and second directions; and
a female biasing portion provided at the guide such as to bias the male connector to the one side in the third direction to bring a male terminal of the male connector into elastic contact with the female terminal.

14. The female connector according to claim 8, wherein
the covers extend from the respective support portions and abut the female body from the one side in the third direction, and
the female connector further comprises a female biasing portion provided at the guide such as to bias the male connector to the one side in the third direction to bring a male terminal of the male connector into elastic contact with the female terminal.

15. The female connector according to claim 9, wherein
the covers extend from the respective support portions and abut the female body from the one side in the third direction, and
the female connector further comprises a female biasing portion provided at the guide such as to bias the male connector to the one side in the third direction to bring a male terminal of the male connector into elastic contact with the female terminal.

16. The female connector according to claim 4, wherein
the guide further includes a bottom between the rails, and
the bottom includes an end portion on the one side in the first direction, the end portion having an opening passing through the bottom in a third direction, the third direction being orthogonal to the first and second directions.

17. The female connector according to claim 5, wherein
the guide further includes a bottom between the rails, and
the bottom includes an end portion on the one side in the first direction, the end portion having an opening passing through the bottom in a third direction, the third direction being orthogonal to the first and second directions.

18. The female connector according to claim 6, wherein
the guide further includes a bottom between the rails, and
the bottom includes an end portion on the one side in the first direction, the end portion having an opening passing through the bottom in a third direction, the third direction being orthogonal to the first and second directions.

19. The female connector according to claim 7, wherein
the guide further includes a bottom between the rails, and
the bottom includes an end portion on the one side in the first direction, the end portion having an opening passing through the bottom in a third direction, the third direction being orthogonal to the first and second directions.

20. A connection structure of a female connector and a male connector, the connection structure comprising:
the female connector according to claim 1; and
a male connector, comprising:
a runner configured to be guided in the first direction by the guide of the female connector such that the runner is floatable along the second direction;
a male body; and
a male terminal held in the male body, the male terminal being contactable with the female terminal of the female connector.

21. A connection structure of a female connector and a male connector, the connection structure comprising:
the female connector according to claim 2; and
a male connector, comprising:
a runner configured to be guided in the first direction by the guide of the female connector such that the runner is floatable along the second direction;
a male body; and
a male terminal held in the male body, the male terminal being contactable with the female terminal of the female connector.

22. The connection structure according to claim 20, wherein
the guide of the female connector further includes a female engagement portion being an engagement hole extending in the second direction,
the male connector further comprises a male engagement portion and a male biasing portion,
the male body includes an accommodation portion configured to accommodate the male engagement portion such that the male engagement portion is movable in the second direction,
the male biasing portion is configured to exert an biasing force on the male engagement portion to one side in the second direction,
the guide of the female connector is configured such that, while guiding the runner of the male connector, the guide presses and moves the male engagement portion to the other side in the second direction against the biasing force of the male biasing portion, and
the male engagement portion is configured such that, when the male terminal is brought into contact with the female terminal and the accommodation portion is brought into communication with the female engagement portion, the male engagement portion is moved to the one side in the second direction by the biasing force of the male biasing portion and engages with the female engagement portion.

23. The connection structure according to claim 21, wherein
the guide of the female connector further includes a female engagement portion being an engagement hole extending in the second direction,
the male connector further comprises.
a male engagement portion and a male biasing portion,
the male body includes an accommodation portion configured to accommodate the male engagement portion such that the male engagement portion is movable in the second direction,
the male biasing portion is configured to exert an biasing force on the male engagement portion to one side in the second direction,
the guide of the female connector is configured such that, while guiding the runner of the male connector, the guide presses and moves the male engagement portion to the other side in the second direction against the biasing force of the male biasing portion, and
the male engagement portion is configured such that, when the male terminal is brought into contact with the female terminal and the accommodation portion is brought into communication with the female engagement portion, the male engagement portion is moved to the one side in the second direction by the biasing force of the male biasing portion and engages with the female engagement portion.
